(19) United States
(12) Patent Application Publication
(10) Pub. No.: US 2006/0185977 A1
(43) Pub. Date: Aug. 24, 2006

(54) Sensor arrangement

(76) Inventors: Peter Ivar Wide, Kristinehamn (SE); Malin Lindouist, Orebro (SE)

Correspondence Address: JOHN LEZDEY, 2875 MCI DRIVE, PINELLAS PARK, FL, 33782, US

(21) Appl. No.: 11/407,808

(22) Filed: Apr. 20, 2006

(30) Foreign Application Priority Data
Jan. 20, 2004 (SE) 0400111-1

(51) Int. Cl. G01N 27/26

(52) U.S. Cl. 204/411

(57) ABSTRACT

The present invention relates to a sensor arrangement adapted to evaluate an instant quality related value of a measured liquid sample (“S”) by applying a discontinuous and/or a continuous signal (“V”) to a number of electrodes (2, 3, 4), which are in electrical contact with said liquid sample (“S”), where a current (11, 12, 13), or equivalent quantity, measured at different potentials (voltage levels) between a reference electrode (3) and at least one working electrode (2 or 4), is evaluated at least at such time sequences where said measured current reflects the presence of any redox-active component, that may either be oxidation, reduction or neutral, at said working electrode (2 or 4). Said reference electrode (3) and said working electrode or electrodes (2, 4) are coordinated to simultaneously be immerged by a flow or stream of liquid samples (“S1”, “S”, “S2”), that said reference electrode (3) and said working electrode or electrodes (2, 4) are connected to an electronic arrangement (5), and that said electronic arrangement includes a first circuit (5a), for evaluating said instant quality related value, and a second circuit (5b), for evaluating any chemical and/or biological changing in said measured instant quality related value, in relation to a stored (5c) reference value.

### TECHNICAL FIELD

The present invention relates generally to a sensor arrangement and more particularly to a sensor or detector arrangement adapted to sense, detect, and/or measure and evaluate an instant quality related value of a measured liquid sample.

A liquid sample, as a reference, is hereinafter illustrated as a sample of pure drinking water and that the sensor arrangement is adapted to evaluate, as an instant value any contamination appearing in said drinking water.

The present invention makes use of a sensor unit, to which is arranged a number of, at least two but usually three or more, electrodes.

A discontinuous, as pulsed, and/or a continuous, voltage signal is applied to these electrodes, which are un-insulated to expose an area in electrical contact with said liquid sample, where a current, or equivalent quantity, is measured at different potentials (voltage levels) applied between a reference electrode and at least one working electrode at different instant of times, whereby said current is evaluated at least at such time sequences where said measured current reflects the presence of any redox-active component.

### BACKGROUND ART

A continuing environmental challenge for most health and security authorities is the monitoring and control of the water inhabitants are to consume. Although the quality of the drinking water is generally high when leaving a purification plant, the water can deteriorate on its way to the inhabitants or consumers.

Problems can often be correlated to contamination in the raw water or occur due to some parts of the water in reservoirs being stagnant and create a growth of algae and/or bacteria.

It is particularly difficult to establish relevant and good condition in water storages. Therefore it is a need for a simple, robust sensor system or arrangement able to measure small changes in the chemical and/or bacterial compound or components of the water, in order to detect a possible quality change, i.e., to prevent contaminated water from reaching a consumer.

The main reason for health related problems, caused by a chemical contamination in the water purification plant, is in Sweden usually too high amounts of fluoride in the raw water and the second most common reason is biocides, described more in detail in the publication denoted [1] and is mentioned and identified at the end of this description.

When people fall ill from drinking water it is usually difficult to find the reason for the illness due to lack of analytical techniques or the taking of water samples or specimens was not sufficient.

Water can also become temporarily contaminated, e.g., from sewage. Therefore, samples and specimen taken after the consumer falls ill will not show anything since the contamination did appear temporary.

A so called “taste sensor”, an “electronic tongue”, has previously been invented and used to differentiate between changing qualities of water, as described in publication [2].

The method used in this approach [3] is based on the principle of LAPV, (Large Amplitude Pulse Voltammetry), a technique where voltage pulses are applied and corresponding current pulses are measured, however at different potentials and at different times. The predetermined measurement sequence is applied between a reference electrode and one working electrode, at times during a predetermined pulse train.

It is also previously known to use SAPV-technique (Small Amplitude Pulse Voltammetry).

The measured current pulse and its time related changing linked to the large or small amplitude technique of the used voltage pulse reflects the redox-active compounds or components, that are either oxidized or reduced at the working electrode or electrodes.

The sensitivity achieved by using the mentioned voltammetric methods is high enough for this application when evaluating each complete current pulse shape in a stagnated test sample of water.

All compounds or components in the measured water sample that are electro-chemically active below the applied potential or voltage value will contribute to the time-related changing in the measured current. Therefore the method is suitable for detecting qualitative changes in a stagnated water sample. The system collects a huge amount of data and requires functions for data reduction before an advanced signal analysis is performed.

Several different sensor systems or arrangements are described as “electronic tongues” or “taste sensors” and used for classifying and distinguishing between different liquids. Some of these sensors are made to “mimic” the human perception of taste and can distinguish between sweet, salt, sour and bitter.

A taste identification outside, such as below, the human detection level is then possible, e.g., [4] and [5]. One sensor system uses ultra thin filters from different types of conducting polymers with a lipid-like material produced using Langmuir-Blodgett technique and impedance spectroscopy [4], [6], [7], and [8]. The sensor can distinguish between un-organic contamination in a water sample substance with similar taste and beverages with distinct tastes. However, when presence of ionic metals in pure water, the sensor is adapted to detect the ions only but is not able to distinguish between the different metals.

The second sensor type is composed of lipid/polymer membranes [9], [10], and depends on what object to taste, different lipid material can be used. Beside the detection of taste in the forms of sweet, salt, sour and bitter this sensor system is also used to detect “umami”, which is a japanese term for implying deliciousness. The concept of global selectivity is also presented [5], where the sensor is able to classify enormous kinds of chemical substances into several different groups, like in natural systems. That is, when a discrimination of each taste is not important, used to more efficiently recognize the total taste experience.

Another electronic tongue for qualitative analysis of different liquids is described as an array of approximately 20 potentiometric chemical sensors: ion-selective, redox sensitive and non-selective sensors with chalcogenid glass and plasticize PVC membranes [11], [12], [13], [14] and [15]. The sensor [16] has been tested on river water artificially contaminated with Cu, CdFeCr, and Zn. When tested on mineral water samples it was observed that only four of the sensors in the array was needed [17].

Also falling within the prior art is the content of the Swedish Patent Publication SE-C2-518 437, wherein there is described and illustrated an electronic arrangement of a kind having applicability to the technique relevant to the present invention.

This publication is especially directed to the use of electrical voltage pulses and using the LAPV and SAPV techniques, where each successive pulse is adapted having a short duration and is applied to the used electrodes, where voltage and/or current transients occurring initial of the pulse duration only are used and registered and thus deleting the reminding and succeeding voltage and/or current values related to evaluated voltage or current pulse.

### DESCRIPTION OF THE PRESENT INVENTION

Technical Problems.

In view of the fact, that the technical considerations of a professional within the relevant field must perform to be able to offer a solution to one or more technical problems comprise initially an insight into the actions or the sequence of actions needed, as well as the means available, the following technical problems should be regarded as relevant for motivating the present invention.

Considering the prior art mentioned above it is to be considered as a technical problem to realise the advantages linked to a construction of a sensor arrangement and especially its sensor unit so said sensor unit may electrically be connected to an electronic arrangement with associated circuits for measuring taste and/or contamination in flowing liquid testing samples and thereby offering a fast and accurate reaction on even small discrepancy from a pre-set value where this discrepancy may represent a predetermined mount of a contamination.

A technical problem is entailed in being able to perceive the significant of utilizing a sensor arrangement with its sensor unit, in which a reference electrode and a working electrode or working electrodes in said sensor unit are coordinated to simultaneously be immerged by a flow or stream of liquid samples and yet causing a fast and accurate reaction on even small amount of predetermined contaminations by connecting said reference electrode and said working electrode or electrodes to an adapted electronic arrangement, whereby said electronic arrangement includes a first circuit, for evaluating an instant quality related value and a second circuit, for evaluating any chemical and/or biological changing or discrepancy in said measured instant quality related value in relation to a measured and/or calculated and/or pre-set stored reference value in a third circuit or register.

A technical problem is also entailed in being able to perceive the significance of utilizing a sensor arrangement and its sensor unit and an arrangement associated electronic arrangement with its circuits, in which said evaluation in said electronic arrangement is based solely upon quality criteria and current signal structures during a number of successive pulses appearing related to quality.

A technical problem is also entailed in being able to perceive the significance of utilizing a sensor arrangement and its sensor unit and an associated electronic arrangement with its circuits, in which said working electrode or electrodes are chosen with an electrical contact surface area exposing towards said flowing liquid samples, qualifying to a definition relevant for a micro-electrode or a ultra micro-electrode.

A technical problem is also entailed in being able to perceive the significance of utilizing a sensor arrangement and an associated sensor unit and an arrangement associated electronic arrangement with its circuits, in which said reference electrode is adapted to expose a larger contact surface area towards said flowing liquid samples than at least one of said used working electrodes.

A technical problem is also entailed in being able to perceive the significance of utilizing a sensor arrangement and its sensor unit and an associated electronic arrangement with its circuits, in which said flow or stream of liquid samples are guided by an open channel or totally enclosed by a tube.

A technical problem is also entailed in being able to perceive the significance of utilizing a sensor arrangement and its sensor unit and an associated electronic arrangement with its circuits, in which said plurality of working electrodes are arranged exactly, or at least essentially exactly, in the direction of the linear flow of said liquid samples.

A technical problem is also entailed in being able to perceive the significance of utilizing a sensor arrangement and its sensor unit and an associated electronic arrangement with its circuits, in which said reference electrode, or more than one electrode, is arranged between two or more adjacent oriented and arranged working electrodes.

A technical problem is also entailed in being able to perceive the significance of utilizing a sensor arrangement and its sensor unit and an associated electronic arrangement with its circuits, in which said one and the same reference electrode is arranged and extended to pass by, however adjacent to, one or more working electrodes.

A technical problem is also entailed in being able to perceive the significance of utilizing a sensor arrangement and its sensor unit and an associated electronic arrangement with its circuits, in which said signals from said working electrode or electrodes are adapted to circuits, included in said electronic arrangement, dependent upon a chosen;
A. Cross-section of the channel or the tube,
B. Ratio of the flow of the liquid samples,
C. Distance and/or chosen direction between used working electrodes.
D. Distance and/or chosen direction between said reference electrode and used working electrode and/or working electrodes, and
E. Exposed surface area and/or areas towards said liquid samples.

A technical problem is also entailed in being able to perceive the significance of utilizing a sensor arrangement and its sensor unit and an associated electronic arrangement with its circuits, in which the number of said working electrodes is chosen to a number of only one or two, depending upon an actual application and/or used electronic arrangement.

A technical problem is also entailed in being able to perceive the significance of utilizing a sensor arrangement and its associated sensor unit and an associated electronic arrangement with its circuits, in which an exposed surface area towards said flowing samples of each of said working electrodes is chosen to 0.01 to 1.0 mm².

A technical problem is also entailed in being able to perceive the significance of utilizing a sensor arrangement and its associated sensor unit and an associated electronic arrangement with its circuits, in which a cross-section area of each of said working electrodes is preferably chosen circular and in such a case allotting a diameter preferably between 0.05 and 1.5 mm.

A technical problem is also entailed in being able to perceive the significance of utilizing a sensor arrangement and its associated sensor unit and an associated electronic arrangement with its circuits, in which only the end portion or end surface of each working electrode is arranged for a direct contact with said flowing liquid samples.

A technical problem is also entailed in being able to perceive the significance of utilizing a sensor arrangement with its associated sensor unit and an associated electronic arrangement with its circuits, in which said reference electrode is chosen from an acid proof stainless steel material, and formed such as a cord or a wire.

A technical problem is also entailed in being able to perceive the significance of utilizing a sensor arrangement and its associated sensor unit and an associated electronic arrangement with its circuits, in which said reference electrode may be chosen cylindrical in cross-section and with a diameter preferably chosen between 2.0 and 4.0 mm.

A technical problem is also entailed in being able to perceive the significance of utilizing a sensor arrangement and its associated sensor unit and an associated electronic arrangement with its circuits, in which said reference electrode is chosen with a length, extending into said measured liquid and flowing samples, preferably between 0.5 and 2.0 mm, such as 1.0 mm.

A technical problem is also entailed in being able to perceive the significance of utilizing a sensor arrangement with its associated sensor unit and an associated electronic arrangement with its circuits, in which said working electrode or electrodes are located or arranged at a certain distance, in many applications it has been found that this distance is to be chosen preferably between 5 and 25 mm, such as between 8 and 12 mm or about 10 mm, from said reference electrode and with two or more electrodes on each side of said reference electrode.

A technical problem is also entailed in being able to perceive the significance of utilizing a sensor arrangement and an associating sensor unit and an associated electronic arrangement with its circuits, in which said reference electrode and/or working electrode or electrodes shall be dimensioned to expose a contact surface towards said liquid samples in the form of pads, from an electrically conductive material, and that said channel or tube is at least partly formed from an electrically insulating material.

A technical problem is also entailed in being able to perceive the significance of utilizing a sensor arrangement and its associated sensor unit and an associated electronic arrangement with its circuits, in which said measured sample, related to said measured liquid samples, is adapted to flow through a sensor unit related plastic tube, onto which a number of reference electrodes and/or a number of associated working electrodes, such as in the form of microelectrodes or the like, are mounted.

A technical problem is also entailed in being able to perceive the significance of utilizing a sensor arrangement and its sensor unit and an associated electronic arrangement with its circuits, in which said measured sample or successively appearing samples are arranged to pass through a hollow plastic tube in a continuous motion, by using a sample pumping equipment.

A technical problem is also entailed in being able to perceive the significance of utilizing a sensor arrangement and a sensor unit and an associated electronic arrangement with its circuits, in which a “potentiostat” is used to apply successsive arranged and different potentials across the reference electrode and used working electrode or electrodes and monitoring the complete measured current pulse and its variation in time at the same time.

A technical problem is also entailed in being able to perceive the significance of utilizing a sensor arrangement and a sensor unit and an associated electronic arrangement with its circuits, in which said electronic arrangement and its circuits is build-in a waterproof and/or embedded in a battery back-up mobile unit.

A technical problem is also entailed in being able to perceive the significance of utilizing a sensor arrangement and a sensor unit and an associated electronic arrangement with its circuits, in which said measured liquid sample is taken directly from tap water, securing the instant quality directly before consuming said water by an optical signal representing pure water quality or a water quality having a contamination falling within predetermined small values.

A technical problem is also entailed in being able to perceive the significance of utilizing a sensor arrangement and its sensor unit and an associated electronic arrangement with its circuits, in which the monitoring of the measured total current pulse is using the significative current changing during a complete voltage pulse.

Solutions.

The present invention is based upon a sensor arrangement adapted to evaluate an instant quality related value of a measured liquid sample by applying a discontinuous (pulsed) and/or a continuous signal to a number of electrodes, which are in electrical contact with said liquid sample, where a current, or equivalent quantity, measured at different potentials (voltage levels) between a reference electrode and at least one working electrode, is evaluated at least at such time sequences where said measured current reflects the presence of any redox-active component, that may either be oxidation, reduction but also neutral, at said working electrode.

For the purpose of solving one or more of the above stated technical problems the present invention suggests that a reference electrode and a working electrode or electrodes in a sensor unit are coordinated to simultaneously be immerged by a flow or stream of liquid samples and that said reference electrode and said working electrode or electrodes are connected to an electronic arrangement.

Said electronic arrangement includes a first circuit, for a complex evaluating of said instant quality related value and a second circuit, for a complex evaluating of any chemical and/or biological changing in said measured instant quality related value in relation to a stored reference value and at a noted difference interpret said difference to a contaminated sample and when said difference exceeds a predetermined value sending a warning signal, such as an optical signal.

Suggested embodiments, exposing the significative features related to the present invention, are that said detection and/or evaluation in said electronic arrangement is based solely upon current signals related to values related to quality criteria.

Said working electrode or electrodes are chosen with an electric sensitive contact surface area towards said liquid sample qualifying to a definition relevant for a micro-electrode or ultra micro-electrode.

Said reference electrode is adapted to expose a larger electric contact surface area towards said liquid sample than at least one of said working electrodes.

Said flow or stream of liquid samples is guided by a channel or a tube.

It is further suggested that a plurality of working electrodes are arranged in the direction of the flow of said liquid samples.

Said reference electrode may be arranged between two adjacent oriented working electrodes and as an alternative is one and the same reference electrode arranged and extended to pass one or more working electrodes.

It is further suggested that signals from said working electrode or electrodes in the sensing unit is adapted to circuits, included in said electronic arrangement, dependent upon a chosen;
A. Cross-section of the channel or the tube.
B. Ratio of the flow of the liquid samples.
C. Distance and/or chosen direction between used working electrodes.
D. Distance and/or chosen direction between said reference electrode and used working electrode and/or working electrodes,
E. Exposed surface area and/or areas towards said liquid samples.

The number of said working electrodes is chosen to one or two, depending upon actual application and/or used electronic arrangement and used voltage pulses and expected current pulses.

It is further suggested that an exposed electrically conductive surface area directed towards said sample of each of said working electrodes is chosen to 0.01 to 1.0 mm² and if a cross-section area of each of said working electrodes is chosen circular the electrode may be allotted a diameter between 0.05 and 1.5 mm.

Only the end portion or end surface of each working electrode is arranged for direct contact with said liquid sample.

Moreover the present invention suggests that the used reference electrode is chosen from an acid proof stainless steel material, such as a cord or a wire, whereby said reference electrode may be chosen cylindrical in cross-section and with a diameter chosen preferably between 2.0 and 4.0 mm, moreover said reference electrode may be chosen with a length, extending into said measured liquid samples, preferably between 0.5 and 2.0 mm, such as 1.0 mm.

The invention further suggests that working electrode or electrodes are located or arranged a distance of preferably 8-15 mm, such as about 10 mm, from said reference electrode and with two or more electrodes on each side of said reference electrode.

Said reference electrode and/or working electrode or electrodes expose a surface towards said liquid samples in the form of pads from an electrically conductive material and that a channel or tube is at least partly formed from an electrically insulating material.

A measured sample, related to said measured liquid samples, is adapted to flow through a plastic tube, onto which a number of microelectrodes are mounted to form said sensor unit.

Said measured sample or samples are arranged to pass through said plastic tube in a continuous motion, by using a sample pumping equipment.

It is further suggested the use of a “potentiostat”, arranged to apply successive arranged pulse-formed potentials across the reference electrode and the used working electrode or electrodes and monitoring the measured current at the same time. The monitoring of the measured current is using the current values and their changing during a complete voltage pulse.

It is further suggested that said electronic arrangement and its circuits is build-in a waterproof and/or embedded in a battery back-up mobile unit, to form the complete sensor arrangement.

The invention offers the possibility that measured liquid samples are taken directly from tap water, securing the instant quality directly before consuming said water.

Advantages

The significative advantages related to this invention is to be seen in the application of or the introduction of a sensor arrangement and its associated sensor unit in a flow of liquid samples and using said sensor arrangement, adapted for evaluating an instant appearing quality related value in relation to a previously stored or set reference value, to calculate any notable difference between a stored reference value and said calculated value and to interpret any significative difference as a contaminated sample and at a detected level or value exceeding a predetermined reference value activate a warning signal.

### BRIEF DESCRIPTION OF THE DRAWINGS

An embodiment, exposing the significant features related of the present invention, will now be described in more detail with reference to a number of experiments carried out and a sensor arrangement and its associated sensor unit and a used electronic arrangement connected to said sensor unit with three electrodes will also be described, whereby;

FIG. 1 under “a” illustrates an experimental set-up and under “b” illustrates a suggested sensor unit.

FIG. 2 illustrates a PCA score plot of ultra pure water and tap water contaminated with fluoride,

FIG. 3 illustrates under “a” and “b” PCA plots of contamination with chlorine and under “a” contaminated ultra pure water and under “b” contaminated tap water.

FIG. 4 illustrates PCA plots for river water and tap water,

FIG. 5 illustrates PCA plots for river water and boiled river water,

FIG. 6 illustrates PCA plots for tap water and boiled tap water,

FIG. 7 illustrates PCA plots for river water compared to tap water and boiled river water

FIG. 8 illustrates trends in a PCA score plot, and

FIG. 9 illustrates in principal a sensor arrangement, according to the present invention, including a sensor unit and an electronic arrangement with associated circuits or functions.

### DESCRIPTION OF THE PREFERRED EMBODIMENT NOW SUGGESTED

It is to be pointed out initially that we have chosen to use in the following description of embodiments at present preferred and including significant characteristic features of the invention and illustrated in the figures of the accompanying drawings special terms and terminology with the intention of illustrating the inventive concept more clearly.

However, it will be noted that the expressions chosen here shall not be seen as limited solely to the chosen terms used in the description, but that each term chosen shall be interpreted as also including all technical equivalents that function in the same or essentially in the same way so as to achieve the same or essentially the same function and/or intention.

The present invention is based upon a new proposed system or sensor arrangement that is suggested to be based on a known voltammetric technique. Further it exhibits new features, which are embedded in a small integrated mobile sensor. This sensitive sensor system and the function of the sensor arrangement will initially be further described in the form of made experiments.

The initial experiments using the new sensor system and its related arrangement show promising results, which will be presented in the following.

Experiments

The Sensor System and its Sensor Arrangement

The proposed sensor system and its sensor arrangement is here based on the principle of Large (or Small) Amplitude Pulse Voltammetry, LAPV (or SAPV).

Different potentials, in the form of successive voltages pulses with decrementing amplitudes, are applied to the three electrodes of the sensing unit and a current between a working electrode and a reference electrode is measured.

The measured current pulse form, appearing during the pulse duration of the voltage pulse, reflects the redox-active compounds or components that are either oxidized or reduced at the working electrodes.

The advantages of the new developed sensor arrangement are robustness, and simplicity, it is through electronic circuit and function adaption and sensor unit design capable to detect even small qualitative changes in the calculation of signals reflected from a measured sample. Each measurement generates in this application a large amount of data during a single pulse duration, these data is to be used and treated in an advanced signal analysis of known design.

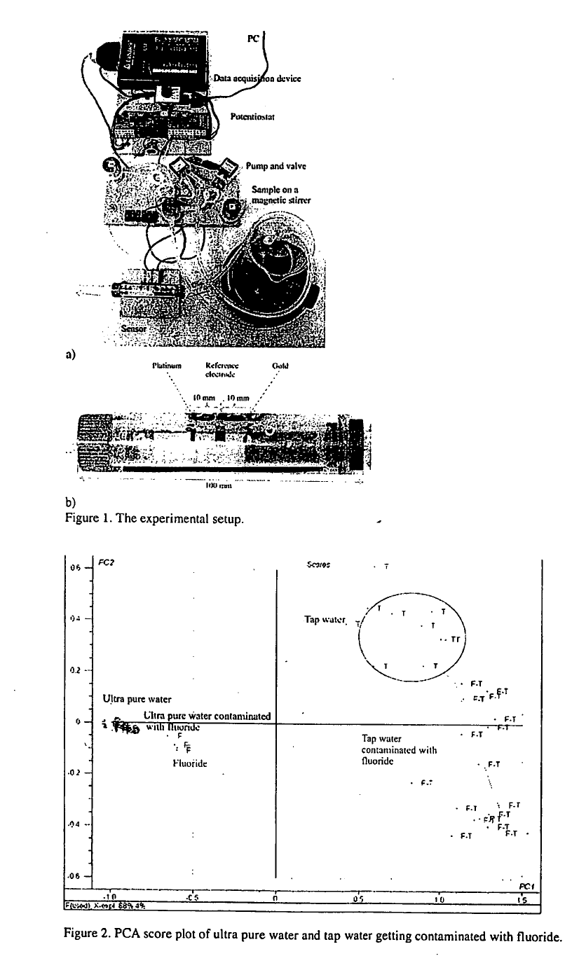

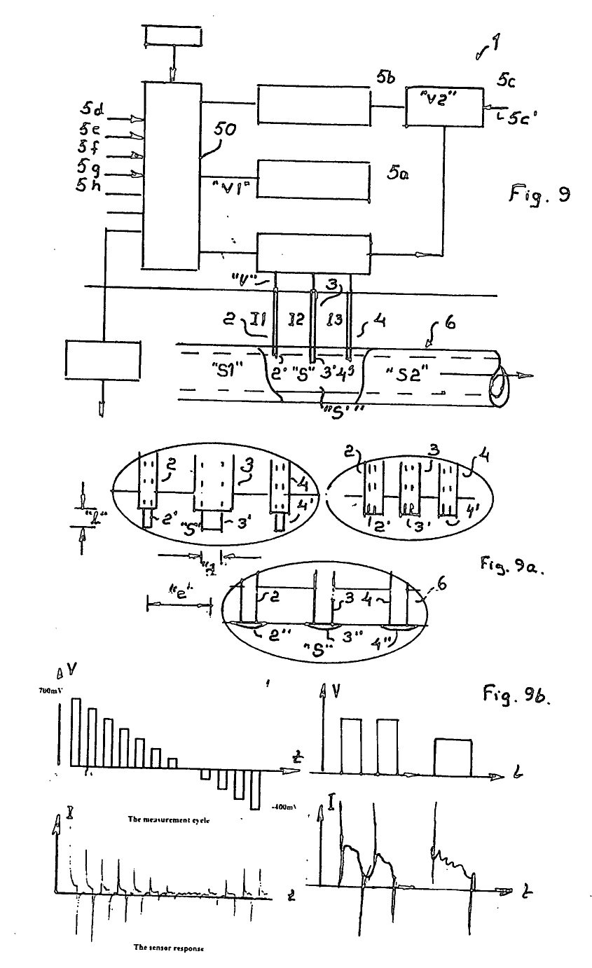

In this specific application the sensor unit has two working microelectrodes, as illustrated in FIGS. 1 and 9, and these electrodes are one made out of gold and the other made of platinum, both with a diameter of 1 mm.

Only the ends or small end sections of wires are in contact with the measured liquid sample. An acid-proof stainless steal wire with a diameter of 3 mm and a length of 1 mm is used as a reference electrode. The working electrodes are located 10 mm from the reference electrode on each side. The measured samples will flow through a plastic tube, onto which microelectrodes are mounted, keeping the measured liquid in a continuous motion. A “potentiostat” is used to apply selected potentials across the reference and the working electrodes and monitoring the measured current and its time-related form at the same time.

A connection to a computer equipment communicates via a USB-based data acquisition device.

The system and the sensor arrangement can be used in many different applications in order to reduce health risks, due to drinking secured water from the tap.

The level of security is depending on the consumers consideration, e.g., age given that children and elderly people needs higher level of security. All the electronic equipment and arrangement connected to the sensor unit can easily be built-in in a waterproof and embedded unit, in order to achieve a moveable sensor system.

Another benefit is that the sensor arrangement and its associated sensor unit is able to act together with underwater vehicles as a separate autonomous unit. The motion of the underwater vehicle will create the necessary flow of liquid samples through a hollow sensor unit. This system and arrangement can then be used in inspections of water reservoirs, harbors, rivers, etc in order to establish its condition to prevent contaminated water to reach the consumers.

The main application, however, is consider to be connecting the sensor unit directly onto the water tap, securing and indicating a good quality directly before consuming the water.

In order to control the water flow during the experimental measurements a pump and a valve were simulating a natural water flow through a sensor unit in the form of a tube.

Measurement.

The measurements were done in order to verify that the sensor arrangement and its sensor unit could separate different water qualities, in respect to its chemical and the biologically content.

Samples of the local drinking water were taken from a water tap at the laboratory. The local drinking water is produced at a purification plant that collects its raw water from the local river. Therefore samples from the river were also collected and tested.

The chemical content of the raw water and drinking water is comparable but there is a huge difference in the amount of bacteria. Samples from both the river water and the tap water were then boiled in order to estimate the possible content of bacteria. The boiled samples were cooled down to room temperature before measured by the sensor arrangement and its sensor unit.

Further analysis of water quality was done by artificially contaminated tap water and ultra pure water with chlorine and fluoride. A solution containing 1.3 mg fluoride per liter pure water was prepared. The solution was tested intact and was also used to contaminate ultra pure water as well as the tap water.

Besides fluoride, the samples were contaminated with chlorine using 5% sodium hypochlorite. The contamination of the samples were done while the tests were running and the sensor unit and the electronic arrangement were continuously collecting data.

A magnetic stirrer kept the concentrations in the water mixtures at an equal level. All the samples were tested in room temperature, between 19 and 22 degrees Celsius.

### I. RESULTS

The new sensor system with its sensor arrangement and a sensor unit has been tested in a laboratory environment. The preliminary analysis was performed using Principal Component Analysis (PCA), which is a mathematical transform to reduce the dimensionality of the data. The results are expressed as observation parameters, called scores, and a plot of these parameters gives a visual expression of the spread of the data.

In a first set of experiments, the system reaction on contaminated water was tested. To begin with the samples of tap water and ultra pure water was detected clean (without any contaminations) as seen in FIG. 2.

During the experiment, chemicals were added at several different times making the concentration of the contaminant stronger. In FIG. 2, a PCA plot of tap water, ultra pure water and a contamination of the water using fluoride are shown.

First, 8 ml of the fluoride solution containing 1.3 mg F per liter is added to the ultra pure water, the sensor arrangement responded to the contamination and more fluoride is added to the sample until it reaches concentration of the fluoride solution alone.

The tap water is also contaminated with the same amount of the fluoride solution and the sensor immediately reacts to the abnormalities in the drinking water.

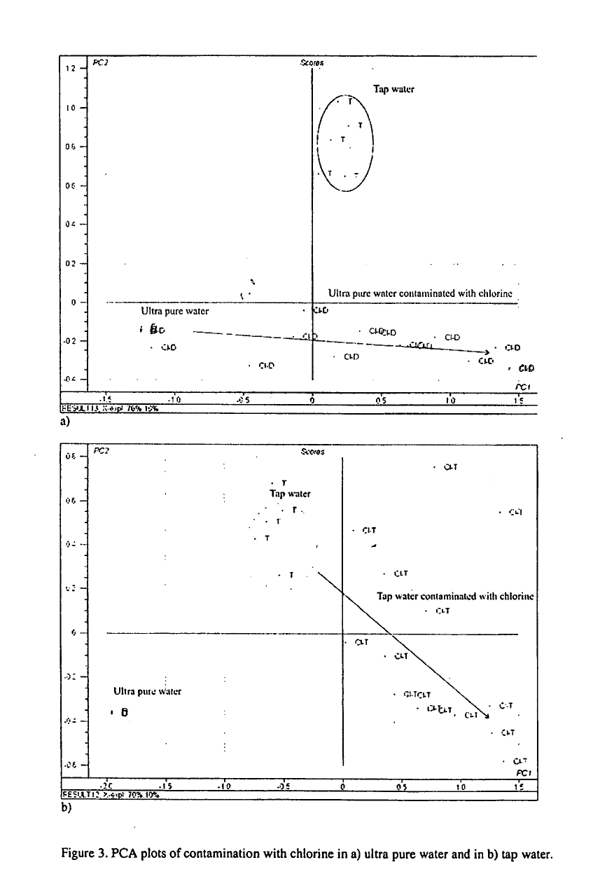

The sensor also reacts very strongly to the contaminant chlorine where drops of 5% sodium hypochlorite were constantly added to the ultra pure water and tap water, as shown in FIG. 3. The tendency shown in this experiment is the more contaminants added to a sample the more the response moves longer to the right, bottom side on the PCA score plot.

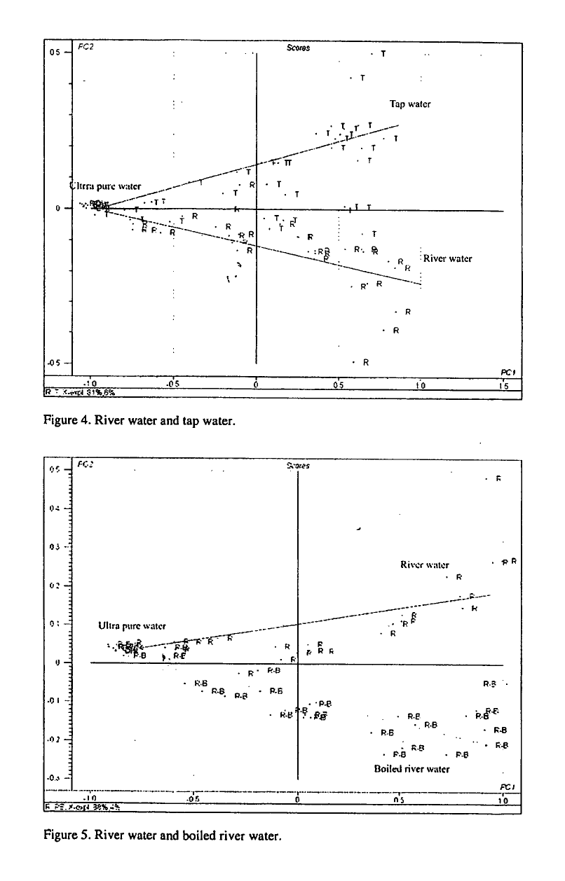

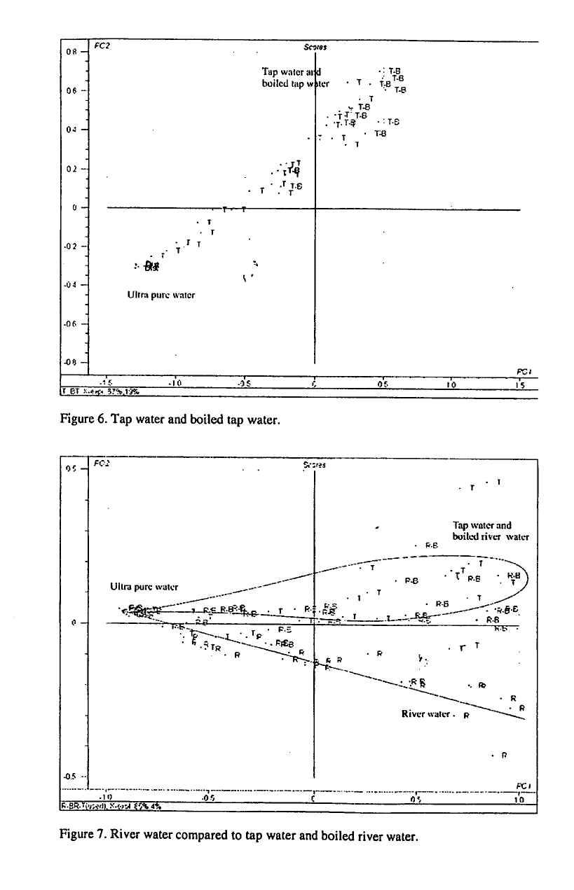

In the next set of experiments the aim was to explore quality changes due to bacteria in tap water and river water, first tested without any modifications and then boiled. While measuring, ultra pure water was constantly added to the samples until the concentration level reached ultra pure water. The pure samples are seen at the right side of the PCA score plot and the more mixed with ultra pure water the response moves more to the left side in the plot. The PCA score plot of tap water and river water FIG. 4, show as expected that there are quality variances between the different types of water. Besides the quality variance in river water and tap water, when comparing river water and boiled river water, as seen in FIG. 5, a change in quality was detected by the sensor system or sensor arrangement. However, when tap water was compared to boiled tap water the system did not find any changes of quality, FIG. 6.

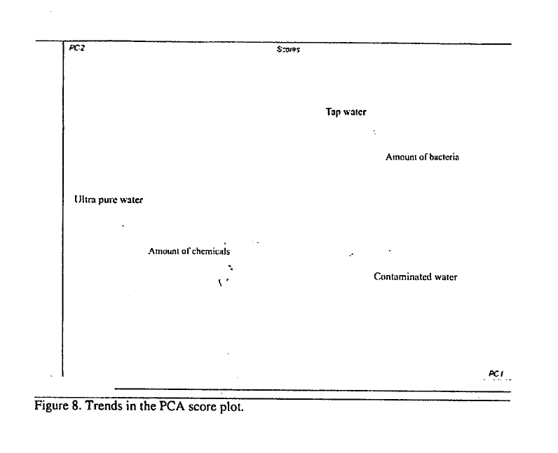

In order to determine what change that occurred when boiling the river water, a plot with the boiled river water compared with river water as well as tap water was made, seen in FIG. 7. The boiled river water sample is approaching the tap water sample, which give the indication that the sensor system or arrangement is sensitive not only to the concentrations of chemicals but also to the amount of bacteria in the samples.

When the samples are plotted against each other using PCA scores, certain tendencies can be seen concerning how different types of water is represented on the plot. When comparing the samples, an interesting behavior of the sensor data can be seen, i.e., the chemical contaminations tends to move along the first principal component while the concentration of bacterial contamination appears to move along the second principal component, as seen in FIG. 8.

Sensor measurements on the tap water have been taken continuously during a long period of time and at random hours. The result still is clear that after analysis the different samples is ending up in the same area in the score plot.

That verifies the stability of the sensor system during the experimental set up.

The sensor arrangement and its sensor unit is able to detect both chemical and biologically changes in water. The experiments presented were done using fluoride, which is the most common chemical appearing in the water that can cause health related problems.

The initial experiments show that the sensor system or arrangement offers a huge possibility in many different applications for supervision of drinking water quality.

### II. CONCLUSIONS

A promising sensor arrangement for automatic detection of contaminated drinking water is presented. Initially experiments with a new sensor system or arrangement with a sensor unit have shown that an improved technique for monitoring and controlling of water quality is presented. The experimental setup as illustrated in FIG. 1 shows that a flow of water running through the sensor unit is able to exhibit promising result for fast detection of changes of the quality in water. When chemicals are added to a sample an immediate reaction is shown in the analysis of the data.

The analysis also shows promising results detecting microbiological contamination. The system is also able to detect qualitative changes at the limit levels that are restricted by governmental regulations. Since the sensor system and the sensor arrangement is mobile there are possibilities to integrate with different autonomous systems able to operate in different environments.

With reference to the embodiment of a sensor arrangement 1, according to the present invention and shown in FIG. 9, this arrangement 1 is adapted to sense, to evaluate and/or detect, and to, calculate an instant quality related value of a measured liquid sample “S” by applying discontinuous (and/or a continuous) signal pulses to a number of electrodes 2, 3, 4, which are in electrical contact with said liquid sample “S”, where a current 11, 12 and 13, or equivalent quantity, measured at different potentials (voltage levels) between a reference electrode 3 and at least one working electrode 2 or 3, is evaluated at least at such time sequences where said measured current reflects the presence of any redox-active component.

This component may either be oxidation, reduction or neutral, at said working electrode 2 or 4.

Said reference electrode 3 and said working electrode 2 or 4 or electrodes 2 and 4 are coordinated to simultaneously be immerged by a flow or stream of liquid samples “S1”, “S” and “S2”, that said reference electrode and said working electrode or electrodes are connected to an electronic arrangement 5.

Said electronic arrangement 5 includes a computer equipment or a processor 50 and a first circuit 5a for calculating and evaluating said instant quality related value “V1” and a second circuit 5b for evaluating any chemical and/or biological changing in said measured instant quality related value “V1” in relation to a stored reference value “V2” in a third circuit 5c.

This reference value “V2” may be evaluated in the arrangement 1 by having a reference sample “S′” passing through the sensor unit 6 and storing this calculated value “V2” in said third circuit 5c, a register or a memory.

This reference value “V2” may be entered via 5c′ into said third circuit 5c as a reference value.

Through said circuits 5a and 5b and additional circuits and functions illustrated said sensing, detection, calculation and evaluation in said electronic arrangement 5 is based solely upon signals that are more or less related to quality criteria.

The present invention is based upon the concept of measuring flowing or streaming samples and evaluate the time-wise changing of each current pulse.

This changing is related to the appearing bacteria but also to the voltage pulse, pulse duration and other criteria such as the shape and form of the sensor unit and the used electronic equipment or arrangement.

Said working electrode or electrodes 2 and 4 are chosen with an electric conductive and contact surface area 2′ and 4′ towards said liquid sample “S” (or sample “S′”) qualifying to a definition relevant for a micro-electrode or a ultra micro-electrode, which means that a micro-electrode is dimensioned to 3 mm² or less and that an ultra micro-electrode is dimensioned to 3 μm² or less.

Said reference electrode 3 is adapted to expose a larger contact surface area towards said liquid sample “S” than at least one of said working surface area electrode 2′ or 4′.

The samples, having the reference numerals “S1”, “S” and “S2”, are guided by a channel or here illustrated as a sensor unit related tube 6, having not shown couplings to a water pipe or water supply conduit.

Thus FIG. 9 illustrates that a plurality of working electrodes 2 and 4 are arranged in the direction (indicated by an arrow) of the flow of said liquid samples “S1”, “S” and “S2” but extending perpendicular to the direction of the flow.

Said reference electrode 3 is here arranged between two adjacent oriented working electrodes 2, 4 and also arranged in the direction of the flow.

As an alternative, and not shown, it is suggested that one and the same reference electrode is arranged in the direction of the flow and extended to pass adjacent one or more working electrodes 2, 4 by introducing the reference electrode in the direction of the flow.

In FIG. 9a is illustrated three different orientations and shapes of the reference electrode 3 and the two working electrodes 2 and 4 more to show that an indication of an expected contamination, due to the time wise changing of the current (I) related to a voltage pulse (V), might be dependent upon a chosen orientation of, the chosen distance between, the chosen voltage pulse shape applied to, the chosen shape of, the chosen exposed conductive surface immerged by said sample of, the chosen orientation of these surfaces of, and chosen other criteria of, saod electrodes 2, 3, and 4.

The time wise changing of the current (I) is also depending upon the duration of each pulse in a pulse train, the chosen voltage (V) changing of each pulse in said train, the chosen rest time between each pulse and the chosen number of pulses in said pulse train, which is schematically illustrated in FIG. 9b in the V/t graphs and the I/t graphs.

This invention is based upon the idea that the shape of and the time wise changing of each total, and sequentially appearing, current (I) pulse in a pulse train (here illustrated as three pulses but less or more pulses may be chosen for a used pulse train), generated or caused in dependence of each applied voltage pulse (V) within said pulse train, shall be easy detected and calculated for sensing and calculation of the content of a predetermined contamination.

FIG. 9b illustrates in this respect additional V/t graphs and I/t graphs where the pulse spectrum in the applied pulse trains are allotted different voltage changes, different durations and different rest times. It is apparent that other pulse/no-pulse ratio may be chosen and adapted to the actual application for detecting and/or calculating the content of a contamination.

Thus it is within the present invention to chose a pulse generating set adapted for generating different pulses and pulse trains. This set might be adapted to generate one or more of the following criteria; causing the same or different amplitudes for each pulse within a pulse train, causing different ripple voltages, causing different pulse intervals, causing different pulse dispersions, considering apparent pulse distortions, causing a pulsating DC voltage causing a pulsating DC current, causing one or more pulse repetition frequencies, causing one or more pulse frequency modulations, causing one or more pulse ratios, causing one or more pulse amplitudes, causing one or more pulse intervals and/or pulse spacing, causing one or more pulse position modulation, causing one or more pulses and pulse trains duration, causing one or more inter-pulse periods, causing one or more pulse repetition periods, causing one or more pulse bursts and/or pulse spectrums, causing one or more pulse peak values.

Output current related signals, appearing as current pulses 11, 13 from said working electrode or electrodes 2 and 4 are sensed and considered by adapted circuits, included in said electronic arrangement 5.

Thus the generated voltage pulses, considering the above stated, are adapted to also consider the influence of;
A. Cross-section of the used channel or the tube 6 (circuit or function 5d).
B. Ratio of the flow of the liquid samples (circuit or function 5e).
C. Distance and/or chosen direction between used working electrodes (circuit or function 5f).
D. Distance and/or chosen direction between said reference electrode and used working electrode and/or working electrodes (circuit or function 5g) and
E. Exposed surface area and/or areas towards said liquid samples (circuit or function 5h).

The practical application of the present invention requires a number of said working electrodes, here illustrated as one or two, but the actual number chosen is more depending upon actual application and/or used electronic arrangement 5.

In a flowing sample “S” the exposed electrically conductive surface areas 2′, 3′, and 4′ towards said sample “S” of each of said reference electrodes 3 and each of said working electrodes 2 and 4 and the inter-relation between these areas are essential, however experiments carried out tend to converge towards an area chosen to 0.01 to 1.0 mm² for the working electrodes 2 and 4.

It has been found preferable to choose the cross-section area of each of said working electrodes 2 and 4 circular and then allotted each electrode a diameter between 0.05 and 1.5 mm.

It has been shown in FIG. 9a three additional different sensor units with different arrangements for the electrodes 2, 3, and 4 and their exposed areas 2′, 3′, and 4′ than in FIG. 9 embodiment.

Thus one embodiment illustrates how the electrodes have un-insulated end regions and are immerged by the sample “S”. The reference electrode 3 is shown with a larger cross-section area and thus a larger un-insulated end region towards said sample “S”.

In a second embodiment only the end portion or an end surface of each working electrode 2 and 4 is arranged with an exposed area 2′, 4′, and for a direct contact with said liquid sample “S”. The reference electrode 4 has here an area 4′ equal to the areas exposed by said working electrodes.

In a third embodiment all electrodes 2, 3 and 4 and their exposed areas 2′, 3′, and 4′ are in the form of pads 2″, 3″, and 4″.

The reference electrode 3 is chosen from an acid proof stainless steel material, such as a cord or wire and is here chosen cylindrical in cross-section and adapted with a diameter “d” chosen between 2.0 and 4.0 mm.

Moreover said reference electrode 3 is chosen with a length “L”, extending into said measured liquid samples “S”, between 0.5 and 2.0 mm, such as 1.0 mm. Moreover said working electrode or electrodes 2 and 4 are located or arranged a distance “e” of 8-15 mm, such as about 10 mm, from said reference electrode 3 and with two or more electrodes on each side of said reference electrode 3. This distance “e” may vary between adjacent reference electrodes and/or adjacent working electrodes.

In the further alternative or third embodiment said reference electrode 3 and/or working electrode or electrodes 2 and 4 expose a contact surface towards said liquid sample “S” in the form of pads, from an electrically conductive material and that a used channel or tube 6 is at least partly formed from an electrically insulating material.

It is further noted that measured sample “S”, related to said measured liquid samples “S1”, “S” and “S2”, is adapted to flow linearly through a plastic tube, onto which a number of microelectrodes are mounted.

Said measured sample “S” or samples are arranged to pass through said plastic tube 6 in a continuous motion, by using a sample pumping equipment, not shown in FIG. 9.

In the FIG. 1 embodiment a “potentiostat” is used to apply successive arranged potentials across the reference electrode and used working electrode 3 or electrodes 2 and 4 and monitoring the measured current and its variation at the same time during the total duration of each pulse.

Especially said electronic arrangement and its circuits is build-in a waterproof and/or embedded in a battery back-up mobile unit and that said measured liquid sample “S” are taken directly from tap water, securing the instant quality directly before consuming said water.

The monitoring of the measured current is using the current changing during a complete voltage pulse.

The present invention is not restricted to the shown embodiments but may be amended within the inventive idea represented by the wording of the following claims.

Hereunder is a reference list of the prior art and their publications mentioned in the section “Background Art”.

[1] D. Rosling, “SLV-15-Dricksvattentillsynen 2002”, Livsmedelsverket, 2003

[2] Lindquist, M. and Wide, P., “Virtual water quality tests with an electronic tongue.”, in Proc. IEEE Instrumentation and Measurement Technology Conference, Budapest, Hungary, May, 2001, vol 2, pp 1320-1324

[3] Winquist, F. and Wide, P. and Lundstom, I., “An Electronic Tongue Based on Voltammetry”, Analytica Chimica Acta, vol 357, 1997, pp 21-31

[4] Riul Jr., A. and Dos Santos Jr., D. S. and Wohnrath, K. and Di Tommazo, R. and Carvalho, A. C. P. L. F. and Fonseca, F. J. and Oliveira Jr., O. N. and Taylor, D. M. and Mattoso, L. H. C., “Artificial taste sensor Efficient combination of sensors made from Langmuir-Blodgett films of conducting polymers and a ruthenium complex and self-assembled films of an azobenzene-containing polymer”, Langmuir, vol 18, no 1, pp 239-245, 2002

[5] Toko, K., “Taste sensor with global selectivity”, Materials Science and Engineering, vol 4, no 2, pp 69-82, June, 1996

[6] Riul Jr., A. and Malmegrim, R. R. and Fonseca, F. J. and Mattoso, L. H. C.“, “An artificial taste sensor based on conducting polymers”, Biosensors and Bioelectronics, vol 18, no 11, pp 1365-1369, 2003

[7] Ferreira, M. and Riul Jr., A. and Wohnrath, K. and Fonseca, F. J. and Oliveira Jr., O. N. and Mattoso, L. H. C., “High-performance taste sensor made from Langmuir-Blodgett films of conducting polymers and a ruthenium complex”, Analytical Chemistry, vol 75, no 4, pp 953-955, 2003

[8] Riul Jr., A. and Soto, A. M. G. and Mello, S. V. and Bone, S. and Taylor, D. M. and Mattoso, L. H. C., “An electronic tongue using polypyrrole and polyaniline”, Synthetic Metals, vol 132, no 2, pp 109-116, 2003

[9] Toko, K., “Electronic Tongue”, Biosensors and Bioelectronics, vol 13, pp 701-709, 1998,

[10] Toko, K., “Taste sensor”, Sensors and Actuators B: Chemical, vol 64, no 1-3, pp 205-215, 2000

[11] Legin, A. and Rudnitskaya, A. and Vlasov, Y. and Di Natale, C. Mazzone, E. and D'Amico, A.“, “Application of Electronic Tongue for Quantitative Analysis of Mineral Water and Wine”, Electroanalysis”, vol 11, no 10-11, pp 814-820, 1999

[12] Legin, A. and Rudnitskaya, A. M. and Vlasov, Y. and Di Natale, C. and D'Amico, A., “Features of the electronic tongue in comparison with the characteristics of the discrete ion-selective sensors”, Sensors and Actuators, B: Chemical, vol 58, no 1-3, pp 464-468, September, 1999

[13] Legin, A. and Rudnitskaya, A. and Vlasov, Yu. and Di Natale, C. and Mazzone, E. and D'Amico, A., “Application of electronic tongue for qualitative and quantitative analysis of complex liquid media”, Sensors and Actuators, B: Chemical, vol 65, no 1, pp 232-234, 2000

[14] Vlasov, Y. and Legin, A. and Rudnitskaya, A. and D'Amicso, A. and Di Natale, C., “‘Electronic tongue’—new analytical tool for liquid analysis on the basis of non-specific sensors and methods of pattern recognition”, Sensors and Actuators, B: Chemical, vol 65, no 1, pp 235-236, 2000

[15] Vlasov, Y. and Legin, A. and Rudnitskaya, A. and Lvova, L. and Di Natale, C. and D'Amico, A., “Evaluation of Italian wine by the electronic tongue: Recognition, quantitative analysis and correlation with human sensory perception”, Analytica Chimica Acta, vol 484, no 1, pp 33-44, 2003

[16] DiNatale, C. and Macagnano, A. and Davide, F. and D'Amico, A. and Legin, A. and Vlasov, Y. and Rudnitskaya, A. and Selezenev, B., “Multicomponent analysis on polluted waters by means of an electronic tongue”, Sensors and Actuators, B: Chemica, vol 44, no 1-3, pp 423-428, October, 1997

[17] Di Natale, C. and Mazzone, E. and Mantini, A. and Bearzotti, A. and D'Amico, A. and Legin, A. V. and Rudnitskaya, A. M. and Vlasov, Y. G., “Electronic tongue distinguishes different mineral waters”, Alta Frequenza Rivista Di Elettronica, vol 11, no 2, pp 88-90, 1999

1. A sensor arrangement adapted to evaluate an instant quality related value of: a measured liquid sample by applying a signal to a number of electrodes, which are in electrical contact with said liquid sample (“S”) where a current, or equivalent quantity, measured at different potentials (voltage levels) between a reference electrode (3) and at least one working electrode (2 or 4), is evaluated at least at such time sequences where said measured current reflects the presence of any redox-active component, at said at least one working electrode (2 or 4), which comprises said reference electrode (3) and said at least one working electrode (2, 4) is coordinated to simultaneously be immerged by a flow of liquid samples (“S1”, “S”, “S2”), that said reference electrode (3) and said at least one working electrode (2, 4) is connected to an electronic arrangement (5), and that said electronic arrangement includes a first circuit (5a) for evaluating said instant quality related value and a second circuit (5b) for evaluating any chemical and/or biological changing in said measured instant quality related value in relation to a stored (5c) reference value.

2. The sensor arrangement of claim 1, wherein said at least evaluation in said electronic arrangement (5) is based solely upon current values related to quality criteria.

3. The sensor arrangement of claim 1, wherein said at least one working electrode (2, 4) is chosen with a contact surface area (2′, 4′) towards said liquid sample qualifying to a definition relevant for an electrode selected from the group consisting of micro-electrode and ultra micro-electrode.

4. The sensor arrangement of claim 1, wherein said reference electrode (3) is adapted to expose a larger contact surface area (3′) towards said liquid sample (“S”) than at least one of said surface related to said at least one working electrodes (2, 4).

5. The sensor arrangement of claim 1, wherein said flow of liquid samples (“S1”, “S”, “S2”) is guided by a channel or a tube.

6. The sensor arrangement of claim 1 or 5, wherein a plurality of working electrodes are arranged in the direction of the flow of said liquid samples.

7. The sensor arrangement of claim 1, wherein said reference electrode is arranged between two adjacent oriented working electrodes.

8. The sensor arrangement of claim 1, wherein the reference electrode is arranged and extended to pass at least one working electrodes.

9. The sensor arrangement of claim 5, wherein output signals from said at least one working electrode is adapted to circuits, included in said electronic arrangement, dependent upon a chosen; A. Cross-section of the channel or the tube. B. Ratio of the flow of the liquid samples. C. Distance and/or chosen direction between used working electrodes. D. Distance and/or chosen direction between said reference electrode and used at least one working electrode and E. Exposed at least one surface area towards said liquid samples.

10. The sensor arrangement as claimed in claim 1, characterized in that the number of said working electrodes is chosen to one or two, depending upon actual application and/or used electronic arrangement.

11. A sensor arrangement of claim 9, wherein an exposed surface area towards said sample of each of said at least one working electrodes is chosen to 0.01 to 1.0 mm².

12. The sensor arrangement of claim 1, wherein a cross-section area of each of said at least one working electrodes is chosen circular and allotted a diameter between 0.05 and 1.5 mm.

13. The sensor arrangement of claim 1, wherein only the end portion of each of said at least one working electrode is arranged for direct contact with said liquid sample

14. The sensor arrangement of claim 1, wherein said reference electrode is chosen from an acid proof stainless steel material.

15. The sensor arrangement of claim 1, wherein said reference electrode is cylindrical in cross-section and with a diameter chosen between 2.0 and 4.0 mm.

16. The sensor arrangement of claim 15, wherein said reference electrode has a length, extending into said measured liquid samples, between 0.5 and 2.0 mm.

17. The sensor arrangement of claim 1, wherein said at least one working electrode is located at distance of 8-15 mm, from said reference electrode and with two electrodes on each side of said reference electrode.

18. The sensor arrangement of claim wherein said reference electrode and said at least one working electrode expose a surface towards said liquid samples in the form of pads from an electrical conductive material and that a channel or tube is at least partly formed from an electrically insulating material.

19. The sensor arrangement of claim 1, wherein a measured sample, related to said measured liquid samples, is adapted to flow through a tube, onto which a number of microelectrodes are mounted.

20. The sensor arrangement of claim 19, wherein said at least one measured sample is arranged to pass through said tube in a continuous motion.

21. The sensor arrangement of claim 1, wherein a potentiostat is used to apply successive arranged potentials across the reference electrode and at least one working electrode and monitoring the measured current at the same time.

22. The sensor arrangement of claim 1, wherein said electronic arrangement and its circuits is build-in a battery back-up mobile unit.

23. The sensor arrangement of claim 1, wherein said measured liquid samples are taken directly from tap water, securing the instant quality directly before consuming said water.

24. The sensor arrangement of claim 1, wherein the monitoring of the measured current is using the current changing during a complete voltage pulse.
